(19) United States
(12) Patent Application Publication
(10) Pub. No.: US 2019/0279212 A1
(43) Pub. Date: Sep. 12, 2019

(54) USING LOCATION PATHS OF USER-POSSESSED DEVICES TO INCREASE TRANSACTION SECURITY

(71) Applicant: Averon US, Inc., Henderson, NV (US)

(72) Inventors: Wendell BROWN, Henderson, NV (US); Mark KLEIN, Henderson, NV (US)

(21) Appl. No.: 16/298,176

(22) Filed: Mar. 11, 2019

Related U.S. Application Data
(60) Provisional application No. 62/640,681, filed on Mar. 9, 2018.

(51) Int. Cl. G06Q 20/40; H04W 4/02; H04W 64/00; G06Q 20/38; H04W 40/24

(52) U.S. Cl. CPC G06Q 20/409; H04W 4/023; H04W 40/244; G06Q 20/382; H04W 64/00

(57) ABSTRACT

Systems, methods, apparatuses, and computer readable media facilitating determination of whether a credit or debit card transaction is being performed by an authorized user. One example method may comprise receiving, from a third-party entity, via a network, a query, the query comprising at least data indicative of a location of a transaction, calculating a co-location probability between the location of the transaction and a current location of the at least one user-possessed device, the co-location probability being a probability that the transaction and the at least one user-possessed device are located within a same predefined geographic area, determining that the co-location probability meets a predefined threshold, and providing a notification indicating that the co-location probability meets a predefined threshold.

### CROSS-REFERENCE TO RELATED APPLICATIONS

This application claims priority to U.S. Provisional Application No. 62/640,681 filed Mar. 9, 2018, the content of which is incorporated herein by reference in its entirety.

### TECHNOLOGICAL FIELD

Embodiments of the invention relate, generally, to transaction security, and more specifically to utilizing location information of user-possessed devices to increase transaction security.

### BACKGROUND

Globally, debit and credit card fraud cost financial institutions over $20 billion dollars annually. These losses have several components that are being addressed with anti-duplication technology (EVM cards, for example), new-customer identity verification procedures, and bank fraudulent transaction prevention measures.

Bank fraudulent transaction detection methods stop over $10 billion in fraudulent transactions annually. The algorithms used by these methods attempt to identify stolen card usage during point-of-sale transactions when the card is present (Card Present=CP) and they attempt to identify stolen card information (number, expiration date, CVV, billing zip) usage when the card is not present (Card Not Present=CNP). The algorithms used to block potentially fraudulent transactions often block valid transactions resulting in unnecessarily suspended cards and leading to customer inconvenience and frustration. Banks and consumers share in the losses from these false negatives. The bank pays a customer service cost and an intangible loss of good will. The consumer may be unable to complete a desired purchase transaction and loses some confidence in their card and bank.

The applicant has discovered problems with current systems, methods, and apparatuses and through applied effort, ingenuity, and innovation, Applicant has solved many of these identified problems by developing a solution that is embodied by the present invention, which is described in detail below.

### BRIEF SUMMARY

In general, embodiments of the present invention provided herein include systems, methods, apparatuses, and computer readable media for detecting a fraudulent transaction, facilitating the determination of the likelihood that a credit or debit card transaction is being performed by the actual card account holder, and/or generating input signals for fraudulent transaction detection algorithms to increase their accuracy, specifically to reduce false negatives.

In some embodiments, a method may be provided for facilitating determination of whether a credit or debit card transaction is being performed by an authorized user, the method comprising receiving, from a third-party entity, via a network, a query, the query comprising at least data indicative of a location of a transaction, calculating a co-location probability between the location of the transaction and a current location of the at least one user-possessed device, the co-location probability being a probability that the transaction and the at least one user-possessed device are located within a same predefined geographic area, determining that the co-location probability meets a predefined threshold, and providing a notification indicating that the co-location probability meets a predefined threshold.

In some embodiments, the method may further comprise determining the current location of the at least one user-possessed device. In some embodiments, the method may further comprise determining the current location of the user-possessed device using at least one of self-reporting, GPS data, carrier signaling, IP address geo-mapping, Bluetooth beacons, proximity to known Wi-Fi hotspots, communication with cohort devices.

In some embodiments, determining the current location of the at least one user-possessed device comprises accessing past location information of the at least one user-possessed device, the past location information of the at least one user-possessed device including at least one data point indicative of a past location of the at least one user-possessed device and a time at which the at least one user-possessed device was at the past location, and calculating a geographic area in which the user-possessed device is in based on the past location of the at least one user-possessed device and the time at which the at least one user-possessed device was at the past location.

In some embodiments, determining the current location of the at least one user-possessed device comprises accessing past location information of the at least one user-possessed device, the past location information of the at least one user-possessed device including a plurality of data points indicative of a plurality of past locations of the at least one user-possessed device and an associated time at which the at least one user-possessed device was at each of the plurality of past locations, and calculating a geographic area in which the user-possessed device is located in based on the plurality of past locations of the at least one user-possessed device and the associated times at which the at least one user-possessed device was at each of the plurality of past locations.

In some embodiments, determining the current location of the at least one user-possessed device comprises accessing location information indicative of a geographic area in which the at least one user-possessed device is located within based on a last known location or a determined path of the at least one user-possessed device.

In some embodiments, determining the current location of the at least one user-possessed device comprises tracking a geographical path of the at least one user-possessed device by receiving, on a periodic basis, data indicative of a present location of the at least one user-possessed device, and storing, periodically, at least a portion of the received data indicative of the present location of the at least one user-possessed device with an associated time at which the user-possessed device was at the present location, and extrapolating the current location from the geographical past based on a determined direction, a determined speed, a determined destination, a determined mode of transportation.

In some embodiments, the current location comprises a set of geographic areas, each geographic area within the set of geographic area being associated with a corresponding probability that the user-possessed device is within the geographic area.

In some embodiments, the method may further comprise calculating a possession probability for the at least one user-possessed device, wherein the calculation of the co-location probability is further a function of the possession probability.

In some embodiments, the method may further comprise accessing location history information, identifying one or more frequented locations, and determining a device possession confirmation event, the device-possession event being a time at which the device returns to or is otherwise located at one of the one or more frequented locations.

In some embodiments, an apparatus may be provided for facilitating determination of whether a credit or debit card transaction is being performed by an authorized user, the apparatus comprising at least one processor and at least one memory including computer program code, the at least one memory and the computer program code configured to, with the processor, cause the apparatus to at least receiving, from a third-party entity, via a network, a query, the query comprising at least data indicative of a location of a transaction, calculating a co-location probability between the location of the transaction and a current location of the at least one user-possessed device, the co-location probability being a probability that the transaction and the at least one user-possessed device are located within a same predefined geographic area, determining that the co-location probability meets a predefined threshold, and providing a notification indicating that the co-location probability meets a predefined threshold.

In some embodiments, the at least one memory and the computer program code are further configured to, with the processor, cause the apparatus to determine the current location of the at least one user-possessed device. In some embodiments, the at least one memory and the computer program code are further configured to, with the processor, cause the apparatus to determine the current location of the user-possessed device using at least one of self-reporting, GPS data, carrier signaling, IP address geo-mapping, Bluetooth beacons, proximity to known Wi-Fi hotspots, communication with cohort devices.

In some embodiments, the computer program code configured to, with the processor, cause the apparatus to determine the current location of the at least one user-possessed device further comprises computer program code, wherein the at least one memory and the computer program code are further configured to, with the processor, cause the apparatus to access past location information of the at least one user-possessed device, the past location information of the at least one user-possessed device including at least one data point indicative of a past location of the at least one user-possessed device and a time at which the at least one user-possessed device was at the past location, and calculate a geographic area in which the user-possessed device is in based on the past location of the at least one user-possessed device and the time at which the at least one user-possessed device was at the past location.

In some embodiments, the computer program code configured to, with the processor, cause the apparatus to determine the current location of the at least one user-possessed device further comprises computer program code, wherein the at least one memory and the computer program code are further configured to, with the processor, cause the apparatus to access past location information of the at least one user-possessed device, the past location information of the at least one user-possessed device including a plurality of data points indicative of a plurality of past locations of the at least one user-possessed device and an associated time at which the at least one user-possessed device was at each of the plurality of past locations, and calculate a geographic area in which the user-possessed device is located in based on the plurality of past locations of the at least one user-possessed device and the associated times at which the at least one user-possessed device was at each of the plurality of past locations.

In some embodiments, the computer program code configured to, with the processor, cause the apparatus to determine the current location of the at least one user-possessed device further comprises computer program code, wherein the at least one memory and the computer program code are further configured to, with the processor, cause the apparatus to access location information indicative of a geographic area in which the at least one user-possessed device is located within based on a last known location or a determined path of the at least one user-possessed device.

In some embodiments, the computer program code configured to, with the processor, cause the apparatus to determine the current location of the at least one user-possessed device further comprises computer program code, wherein the at least one memory and the computer program code are further configured to, with the processor, cause the apparatus to track a geographical path of the at least one user-possessed device by receiving, on a periodic basis, data indicative of a present location of the at least one user-possessed device, and storing, periodically, at least a portion of the received data indicative of the present location of the at least one user-possessed device with an associated time at which the user-possessed device was at the present location, and extrapolate the current location from the geographical past based on a determined direction, a determined speed, a determined destination, a determined mode of transportation.

In some embodiments, the current location comprises a set of geographic areas, each geographic area within the set of geographic area being associated with a corresponding probability that the user-possessed device is within the geographic area.

In some embodiments, the at least one memory and the computer program code are further configured to, with the processor, cause the apparatus to calculate a possession probability for the at least one user-possessed device, wherein the calculation of the co-location probability is further a function of the possession probability.

In some embodiments, the at least one memory and the computer program code are further configured to, with the processor, cause the apparatus to access location history information, identify one or more frequented locations, and determine a device possession confirmation event, the device-possession event being a time at which the device returns to or is otherwise located at one of the one or more frequented locations.

In some embodiments, a computer program product may be provided for facilitating determination of whether a credit or debit card transaction is being performed by an authorized user, the computer program product comprising at least one non-transitory computer-readable storage medium having computer-executable program code instructions stored therein, the computer-executable program code instructions comprising program code instructions for receiving, from a third-party entity, via a network, a query, the query comprising at least data indicative of a location of a transaction, calculating a co-location probability between the location of the transaction and a current location of the at least one user-possessed device, the co-location probability being a probability that the transaction and the at least one user-possessed device are located within a same predefined geographic area, determining that the co-location probability meets a predefined threshold, and providing a notification indicating that the co-location probability meets a predefined threshold.

In some embodiments, the computer-executable program code instructions further comprise program code instructions for determining the current location of the at least one user-possessed device. In some embodiments, the computer-executable program code instructions further comprise program code instructions for determining the current location of the user-possessed device using at least one of self-reporting, GPS data, carrier signaling, IP address geo-mapping, Bluetooth beacons, proximity to known Wi-Fi hotspots, communication with cohort devices.

In some embodiments, determining the current location of the at least one user-possessed device comprises (i) accessing past location information of the at least one user-possessed device, the past location information of the at least one user-possessed device including at least one data point indicative of a past location of the at least one user-possessed device and a time at which the at least one user-possessed device was at the past location, and (ii) calculating a geographic area in which the user-possessed device is in based on the past location of the at least one user-possessed device and the time at which the at least one user-possessed device was at the past location.

In some embodiments, determining the current location of the at least one user-possessed device comprises (i) accessing past location information of the at least one user-possessed device, the past location information of the at least one user-possessed device including a plurality of data points indicative of a plurality of past locations of the at least one user-possessed device and an associated time at which the at least one user-possessed device was at each of the plurality of past locations, and (ii) calculating a geographic area in which the user-possessed device is located in based on the plurality of past locations of the at least one user-possessed device and the associated times at which the at least one user-possessed device was at each of the plurality of past locations.

In some embodiments, determining the current location of the at least one user-possessed device comprises accessing location information indicative of a geographic area in which the at least one user-possessed device is located within based on a last known location or a determined path of the at least one user-possessed device.

In some embodiments, determining the current location of the at least one user-possessed device comprises tracking a geographical path of the at least one user-possessed device by receiving, on a periodic basis, data indicative of a present location of the at least one user-possessed device, and storing, periodically, at least a portion of the received data indicative of the present location of the at least one user-possessed device with an associated time at which the user-possessed device was at the present location, and extrapolating the current location from the geographical past based on a determined direction, a determined speed, a determined destination, a determined mode of transportation.

In some embodiments, the current location comprises a set of geographic areas, each geographic area within the set of geographic area being associated with a corresponding probability that the user-possessed device is within the geographic area.

In some embodiments, the computer-executable program code instructions further comprise program code instructions for calculating a possession probability for the at least one user-possessed device wherein the calculation of the co-location probability is further a function of the possession probability.

In some embodiments, the computer-executable program code instructions further comprise program code instructions for accessing location history information, identifying one or more frequented locations, and determining a device possession confirmation event, the device-possession event being a time at which the device returns to or is otherwise located at one of the one or more frequented locations.

Other systems, methods, and features will be, or will become, apparent to one with skill in the art upon examination of the following figures and detailed description. It is intended that all such additional systems, methods, features to be included within this description, be within the scope of the disclosure, and be protected by the following claims.

### BRIEF DESCRIPTION OF THE DRAWINGS

Having thus described embodiments of the invention in general terms, reference will now be made to the accompanying drawings, which are not necessarily drawn to scale, and wherein:

FIG. 1 illustrates an example system within which embodiments of the present invention may operate.

FIG. 2 illustrates a block diagram showing an example apparatus for facilitating the determination of the likelihood that a credit or debit card transaction is being performed by the actual card account holder in accordance with some exemplary embodiments of the present invention.

FIG. 3 illustrates an example system within which embodiments of the present invention may operate.

FIG. 4 illustrates a flowchart depicting example operations for performing a determination process in accordance with some example embodiments discussed herein.

FIGS. 5A, 5B, and 5C illustrate flowcharts depicting example operations for performing a location determination process, in accordance with some example embodiments discussed herein.

FIG. 6 illustrates a flowchart depicting example operations for performing a device possession determination process, in accordance with some example embodiments discussed herein.

### DETAILED DESCRIPTION

Embodiments of the present invention now will be described more fully hereinafter with reference to the accompanying drawings, in which some, but not all, embodiments of the invention are shown. Indeed, embodiments of the invention may be embodied in many different forms and should not be construed as limited to the embodiments set forth herein; rather, these embodiments are provided so that this disclosure will satisfy applicable legal requirements. Like numbers refer to like elements throughout.

As used herein, the terms “data”, “content”, “information”, and similar terms, may be used interchangeably to refer to data capable of being captured, transmitted, received, displayed, and/or stored in accordance with various example embodiments. Thus, use of any such terms should not be taken to limit the spirit and scope of the disclosure. Further, where a computing device is described herein to receive data from another computing device, it will be appreciated that the data may be received directly from another computing device or may be received indirectly via one or more intermediary computing devices, such as, for example, one or more servers, relays, routers, network access points, base stations, and/or the like, sometimes referred to herein as a “network.” Where multiple networks are described, it will be appreciated that each network in the multiple networks may utilize entirely different components, share some components, share all components, and otherwise be configured such that a first network and a second network may be entirely separate networks, partially the same network, or entirely the same network.

### Overview

The system of the invention generates input signals for fraudulent transaction detection algorithms to increase their accuracy, specifically to reduce false negatives.

By tracking the geographical path of user-possessed devices, the system can produce a set of probability factors related to the motion, trajectory, and history of the user's travel. These factors may be published by the system along with a location probability score that is produced in response to, for example, a query supplying an arbitrary putative user location or user card transaction location.

The invention uses the location of user device (e.g., the user's mobile phone, and/or other user-possessed devices, such as, for example, a laptop, an automobile, or IoT device), to locate the user. Some devices, such as the mobile phone, have become as ubiquitous as a wallet or purse. Some mobile devices are kept in close proximity to the user and under their control, and therefore such devices' locations are a very reliable proxy for user location.

The system may determine device location using GPS, carrier signaling (cell tower location), IP address geo-mapping, Bluetooth beacons, proximity to known Wi-Fi hotspots, communication with cohort devices, and/or other techniques. The invention may, additionally, periodically confirm device possession using carrier signaling or other techniques.

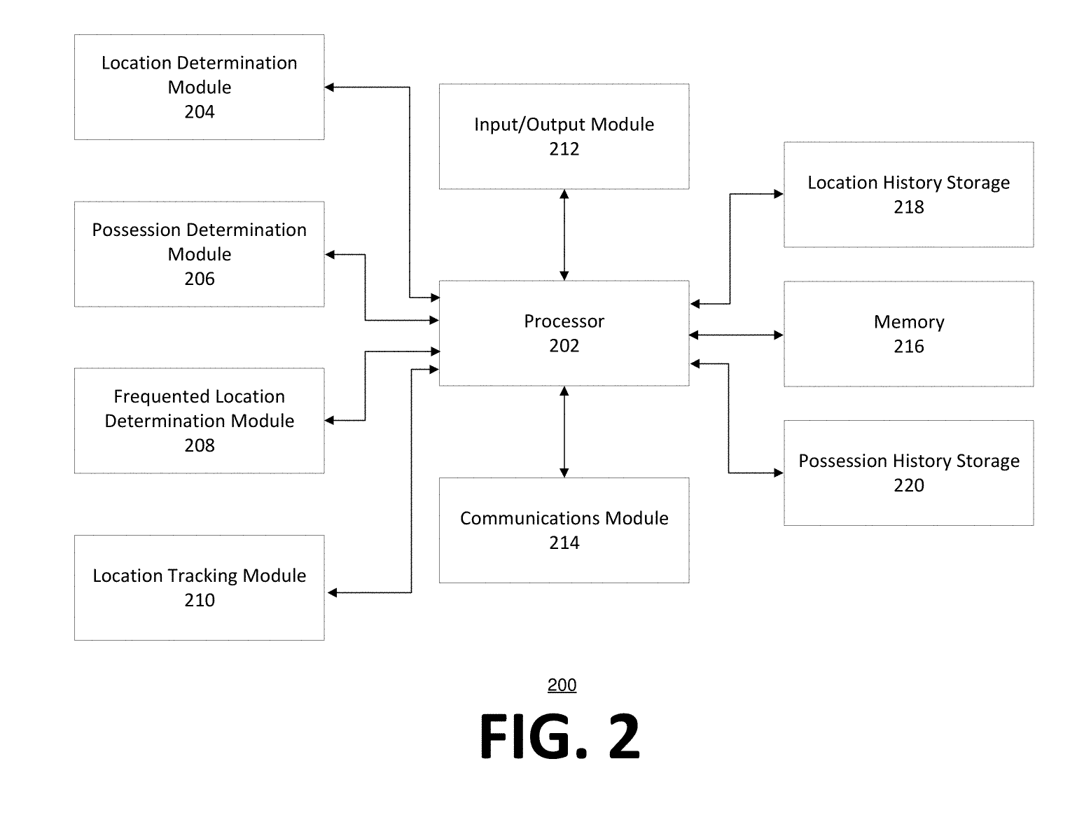

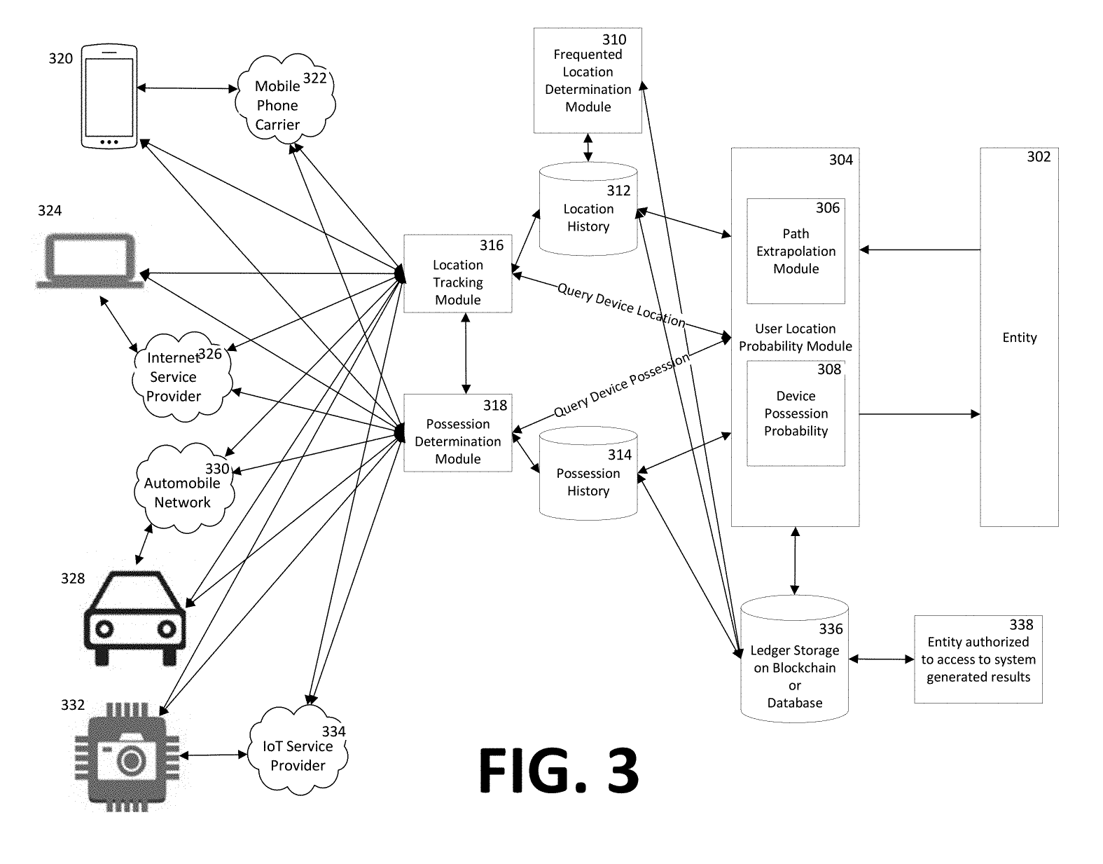

FIG. 3 shows an exemplary system and data flows of an example use case, (e.g., the determination of the likelihood that a credit or debit card transaction is being performed by the actual card account holder). When a financial institution's anti-fraud algorithm decides to incorporate location checking in its determination of whether to permit or deny a transaction, a third party entity 302 queries the system (e.g., a user location probability module 304, which may be embodied by a location determination module as shown in FIG. 2) with the location of the source of the transaction. The location can be expressed, for example, as a circle (i.e., a point and a diameter) reflecting the uncertainty of transaction location, or a set of circles, or other location representations. A financial-institution, and/or the system 300, may use any of several techniques to locate the source of the transaction, including location of merchant, IP address of originating transaction, caller ID/ANI of telephonic transactions, or other techniques.

The invention compares the location of the source of a transaction to the path of the user's devices to produce a score reflecting the co-location probability between the two locations, for example using user location probability module 304, the path extrapolation module 306, and/or the device possession probability module 308. In one embodiment, the score is represented as a probability multiplied by 100. In this case, 100 would signify certain co-location of the user and the transaction and 0 would signify impossible co-location. The system may apply Artificial Intelligence (AI) or other methods to set parameters that maximize or minimize system goals such as false-negatives, false-positives, customer service costs, etc.

Location of the user is tracked (e.g., by location tracking module 316) and recorded periodically, to for example, location history database 312, with a frequency that is fixed or selected based on inferred user behavior. For example if the user enters an airport, the frequency may be increased to accurately determine flight departure and arrival times. The system can use published flight routes and logs in its user path processing to increase user location confidence. At the time of a transaction, the location history 312 may be accessed and/or processed to determine the probability that the user is at the transaction location (e.g., by the path extrapolation module 306). Maximum speed constraints and logical routes are considered in this calculation. A transaction can be the use of a payment card (credit card, debit card, gift card, etc.), or a pay service such as ApplePay, GooglePay, or PayPal.

The system may calculate a possession probability (e.g., by device possession probability module 308) for each user possessed device it is tracking, such as, for example, a mobile phone 320, which may be tracked fir the mobile phone carrier 322, a laptop or computer 324, which may be tracked via an internet service provider 326, an automobile, device associated with an automobile, such as a sensor or the like 328, which may be tracked via an automobile network 330, and/or an IoT device 332, which may be tracked via any of the above networks or a IoT service provider 334. The possession probability can be published, for example, via ledger storage or blockchain 336, and/or used to determine user location probability. To calculate a possession probability, the system (e.g., by frequented location determination module 310) may examine location history, for example, accessed from location history storage 312, to determine home, work, and other frequented locations and, in some embodiments, assign a possession-confirmation weighting to those locations. When a user's device returns to a frequented location, the system recognizes a possession confirmation event.

User device possession can also be confirmed (e.g., by possession determination module 318) by user entry of biometric information into the device, by carrier signaling (authorized usage, header-injection/enrichment, or other in-band or out-of-band techniques), by user response to a query from an application running on the device, by user response to an SMS or other message received on the device, by an authentication event when logging into an Internet service, or by other techniques. A credit or debit card can be considered a user-possessed device and may be tracked by the system using transaction locations supplied externally by a customer of the system's published data, or internally by the system by monitoring transactions, RFID, proximity to mobile devices if the card can be queried, or other tracking techniques.

User-possessed devices types that may be tracked by the system include mobile phone, laptop, car, smart-luggage, IoT and other trackable devices. The system may also consider the location of family, friends, and colleagues who the system determines live or travel together.

In another embodiment, user location probability maybe periodically published (e.g., by ledger storage on blockchain or database 336) for consumption by authorized, and/or opted-in, entities 338, which may be, for example, financial institutions. The location probability may include a set of geographic areas each with a corresponding probability.

In some embodiments, user location may be entered and captured by the system from external sources including self-reporting by the user themselves, or by authorized entities such as the customer service department or consumer application of the user's bank. Location may be contemporaneous or can be time-stamped in the future to reflect planned travel. User-reported future travel plans increase the location probability when devices are detected in the specified region in the specified time period.

Location history, location probability results, possession history, possession probabilities, frequented locations, and other system generated results may be stored on a recording ledger, one example of which is a blockchain (i.e., (e.g., ledger storage on blockchain 336). Entities may be authorized to access the user's ledger, either in whole, or restricted by time or another constraint. Published location results can be dithered into a larger area to increase privacy. This dithering can be applied at time of write to the ledger or by the decryption algorithm used to access the ledger.

In another embodiment, user and/or device location information may be stored or reported in an obfuscated fashion, by storing “hashes” of locations/regions or other means, and not by storing or reporting the actual locations themselves. As an example, if the system records that a user is regularly in location 117 and 118, then at some point the user appears in location 118, the “match to prior known location” may be a useful signal, even if the actual geographic value of location 118 is not reported, or possibly not stored by the system.

In another embodiment, the system may not store any actual user or device location information. Instead, the system may store obfuscated location information using, for example, a hash function on reported device or user locations before storage. This may be done in a way that currently reported locations can be detected as nearby to prior locations, even if those prior locations are obfuscated. One way to implement this “nearby prior locations even when the prior locations are obfuscated (i.e., hashed)” is to store all “nearby squares” as a set of obfuscated locations in a grid at the size granularity of location reporting, or in some embodiments, a size granularity adjusted by the system, surrounding the user's location whenever location is reported to the system. For example, using a chessboard pattern, where the user is currently at location (4, 4) of an 8×8 grid of square areas of arbitrary size (e.g., determined a-priori or dynamically by the system). When the system detects that the user or their device(s) is/are at the (4, 4) location, the system may store all sixty-four obfuscated grid locations (e.g., the one location in the center of the grid plus the sixty-three surrounding grid locations). Grid size may be arbitrarily large to meet commercial requirements. When the system, upon receiving newly reported location information, detects the user and/or their devices' obfuscated/hashed location values match any of the values in the set of grid hashed location values stored previously, the system may recognize that the user or their device(s) is/are “near” the prior location, even though all stored location information is obfuscated. Location information, like other information often deemed private, such as Personally Identifiable Information (PII), may be stored obfuscated/hashed for privacy, legal, or other reasons.

### Definitions

The term “network” refers to one or more servers, relays, routers, network access points, base stations, and/or the like, capable of transmitting information and/or requests between computing devices. For example, in some embodiments, a network may be a mobile carrier network. A person having ordinary skill in the art would understand a “carrier network”, “mobile carrier”, or the like refers to a telecoms network infrastructure provided by a telecoms service provider. In another embodiment, a network may refer to a Wi-Fi network, WLAN, LAN, WAN, or the like. In some embodiments, a “first network” and a “second network” may refer to two separate networks. Alternatively, in some embodiments, a “first network” and a “second network” may refer to the same network, such that the first and second networks transmit information over some shared components or all shared components. Further, in some embodiments, a “first network” and a “second network” may be used to indicate that the two networks are out-of-band with respect to one another.

One having ordinary skill in the art would readily recognize the term “out-of-band” refers to a network or data channel that is separate from a primary network or data channel. For example, in some embodiments, a device network may be out-of-band from a communications network. In some embodiments, the device network may be a carrier network while the communications network may be a Wi-Fi or WLAN network.

A “service provider” refers to any entity that provides services to a user via a user device. For example, a service provider may be an online retailer, software as a service provider, other e-commerce business, or the like. A service provider may be associated with “service provider identification information” that uniquely identifies the service provider. For example, service provider identification information may comprise a combination of attributes associated with service provider (e.g., a service provider name, location, or the like) or may comprise an identification number provided by the service provider or generated by the user certificate system. Service provider identification information may be used to associate a particular service provider with a particular user certificate, such that different user certificates may be associated with different service providers.

The term “user device” refers to a device (e.g., a mobile device) configured to interact with a service provider and/or other user devices through one or more networks. Examples of a user device may include a laptop, mobile device (e.g., smartphone and other mobile devices), tablet, personal computer, chip embedded card, credit card, debit card, key fob, or the like, or any combination thereof.

In an example embodiment, a user device may be configured to communicate with another user device, such as to perform a device possession confirmation event and/or to contact the authorization system. For example, a first user device (e.g., a laptop or personal) may be used in a transaction. In response, the authorization system, or mobile phone carrier and/or internet service provider, may provide a link to a second user device (e.g., a mobile phone, smartphone or the like) associated with the user or user profile. The user may then interact with the second user device to access the link and transmit confirmation. The second device may receive information useful in completing a device possession confirmation event, such as a SMS message comprising a one-time password. Alternatively, the second device may display an interface prompting user interaction to complete a device possession confirmation event, for example an interface configured to receive and verify a biometric indicator matches with a biometric indicator associated with the user identity.

The term “header enrichment” refers to a process for authenticating a mobile device or an owner of the mobile device via a Direct Autonomous Authentication process, involving a packet header enrichment in which packet headers comprise device identification information, for example, “injected” therein by a trusted party such as a carrier, network provider or through a login process. For example, in some embodiments, a network may inject a phone number associated with a mobile device within packet headers. In this manner, the authentication system may obtain device identification information without user input. Application Ser. No. 15/424,595, entitled “Method and Apparatus for Facilitating Frictionless Two-Factor Authentication,” filed on Feb. 3, 2017, which is hereby incorporated by reference in its entirety, describes a number of exemplary processes for performing a Direct Autonomous Authentication process.

The term “identification information” should be understood to refer to information that, alone or in combination with other identification information, identifies a particular user, entity, or device. For example, identity information may include a name, a phone number, a social security number, a birthday, an identification number, or the like. In some embodiments, identification information may be sent from a user device to a user certificate system, or from a service provider to a user certificate system, which may store all or part of the identification information associated with, or as part of, public certificate information.

The term “biometric indicator” refers to data representing a biometric feature associated with a user. Examples of a biometric indicator include, but are not limited to, a fingerprint scan, a face scan, an iris scan, and a walking gait.

The term “device possession confirmation event” refers to receiving information on the user device such that the information received, such as information resulting from a user interaction or received automatically, verifies that the user interacting with the user device is an authenticated user. For example, in some embodiments, a device possession confirmation event may involve receiving, on the user device or another user device, a one-time password sent over SMS to the mobile phone number associated with an authenticated user. Alternatively, a device possession confirmation event may involve receiving, on the user device or another user device, a passcode associated with the user device, a second device, or a dedicated passcode device. In some embodiments, the device possession confirmation event may involve receiving, on the user device or another user device, a biometric indicator (e.g., a retina scan, fingerprint, facial recognition scan, or the like) and matching that biometric indicator with that of the authenticated user. In some embodiments, the device possession confirmation event may cause a service provider to provide information attesting that the user device is associated with an authenticated user (e.g., a mobile carrier attesting that the phone number associated with the user device is controlled by the authenticated user).

The term “ledger” refers to a log of transactions, such as a log of transaction reports, wherein the log of transactions allows auditing by authorized parties. In some embodiments, the ledger may be stored in a transaction database. In an additional embodiment, the ledger may be stored via a blockchain, such that each new transaction reports is appended to the end of the chain.

### Technical Underpinnings and Implementation of Exemplary Embodiments

An authorization system 102 in accordance with an embodiment of the invention herein facilitates the detection of a fraudulent transaction, which may include facilitating the determination of the likelihood that a credit or debit card transaction is being performed by the actual card account holder, and/or generating input signals for fraudulent transaction detection algorithms to increase their accuracy, specifically to reduce false negatives.

Conventional systems either attempt to identify stolen card usage during point-of-sale transactions when the card is present (Card Present=CP) or attempt to identify stolen card information (number, expiration date, CVV, billing zip) usage when the card is not present (Card Not Present=CNP). The algorithms used to block potentially fraudulent transactions often block valid transactions resulting in unnecessarily suspended cards.

Embodiments described herein facilitate the determination of the likelihood that a credit or debit card transaction is being performed by the actual card account holder.

Further in particular, various embodiments are directed to determining a co-location of a user-possessed device and a transaction and to determining device possession.

### System Architecture

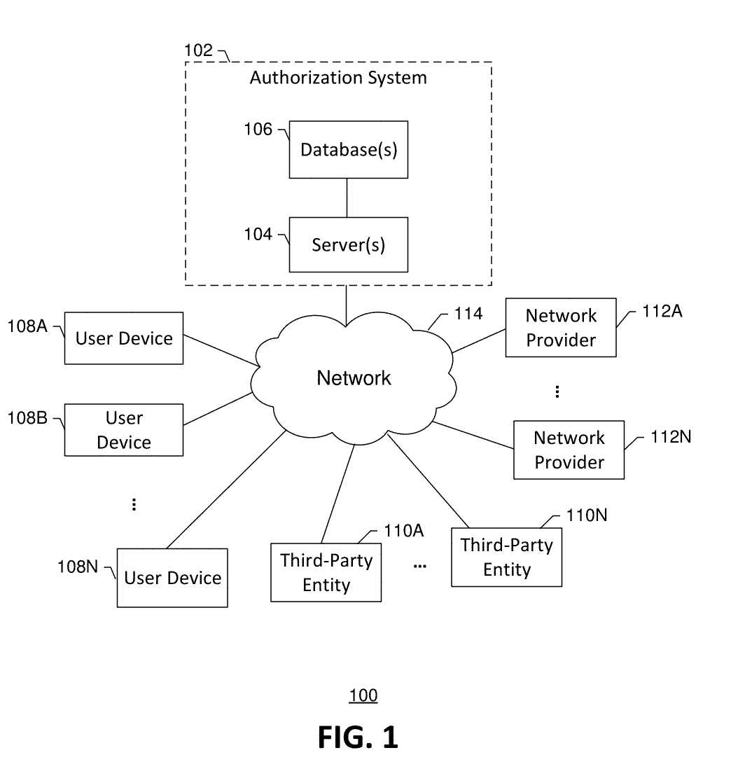

FIG. 1 is a system diagram showing an exemplary system, which may include one or more devices and sub-systems that are configured to implement embodiments discussed herein, and in particular, to implement a fraud detection process via an authorization system 102.

Turning to the FIG. 1, the system may include authorization system 102, including server 104 and database 106, one or more user devices 108A, 108B, and 108N, network providers 112A-112N, and third party entities 110A-110N. Server 104 may include any suitable network server and/or other type of processing device to communicate with other devices via one or more networks, such as Network 114.

Authorization system 102, user devices 108A, 108B, and 108N, network providers 112A-112N, and third party entities 110A-110N may be configured to communicate with each other over a network, such as network 114, which may be the Internet or the like. In some embodiments, the network by which user devices 108A, 108B, and 108N may be configured to communicate with authorization system 102, network providers 112A-112N, and third party entities 110A-110N may be different or “out of band” with network 114 (e.g., FIG. 3 below shows exemplary embodiments where various modules communicate with various user devices via a mobile network, hosted, for example, by a mobile carrier, an automobile network, an internet of things (IoT) service network, and the like).

In some embodiments, user devices 108A, 108B, and 108N may be a smartphone, mobile device, tablet device, kiosk device, internet of things (IoT) device, an automobile or device coupled to an automobile, or other electronic device. In some embodiments, user devices 108A, 108B, and 108N may include one or more sensors configured to detect, identify, or receive a biometric trait. For example, in an exemplary system, one or more of user devices 108A, 108B, and 108N may be a smartphone with a hardware configured to perform a fingerprint scan or a facial recognition scan.

Authorization system 102 may be embodied by one or more computing systems, such as apparatus 200 shown in FIG. 2. As illustrated in FIG. 2, the apparatus 200 may include a processor 202, a location determination module 204, a possession determination module 206, a frequented location determination module 208, a location tracking module, 210, input/output module 212, communications module 214, a memory 216, location history storage 218, and possession history 220. The apparatus 200 may be configured to execute the operations described above with respect to FIG. 1, and below with respect to FIGS. 3, 4, 5A, 5B, 5C, and 6. Although these components 202-220 are described with respect to functional limitations, it should be understood that particular implementations necessarily include the use of particular hardware. It should also be understood that certain of these components 202-220 may include similar or common hardware. For example, two sets of circuitry may both leverage use of the same processor, network interface, storage medium, or the like to perform their associated functions, such that duplicate hardware is not required for each module. The use of the term “module” as used herein with respect to components of the apparatus should therefore be understood to include particular hardware configured to perform the functions associated with the particular module as described herein.

The term “module” should be understood broadly to include hardware and, in some embodiments, software for configuring the hardware. For example, in some embodiments, “module” may include processing circuitry, storage medium, network interfaces, input/output devices, and the like. In some embodiments, other elements of the apparatus 200 may provide or supplement the functionality of a particular module, or particular modules. For example, the processor 202 may provide processing functionality, the memory 216 may provide storage functionality, the communications module 214 may provide network interface functionality, and the like.

In some embodiments, the processor 202 (and/or co-processor and any other processing module assisting or otherwise associated with the processor) may be in communications with the memory 216 via a bus for passing information among components of the apparatus. The memory 216 may be non-transitory and may include, for example, one or more volatile and/or non-volatile memories. In other words, for example, the memory may be an electronic storage device (e.g., a computer readable storage medium). The memory 216 may be configured to store information, data, content, applications, instructions, or the like, for enabling the apparatus to carry out various functions in accordance with example embodiments of the present invention.

The processor 202 may be enabled in a number of different ways and may, for example, include one or more processing devices configured to perform independently. Additionally or alternatively, the processor may include one or more processors configured in tandem with a bus to enable independent execution of instructions, pipelining, and/or multithreading. The use of the term “processing module” may be understood to include a single core processor, a multi-core processor, multiple processors internal to the apparatus, and/or remote or “cloud” processors.

In an example embodiment, the processor 202 may be configured to execute instructions stored in the memory 216 or otherwise accessible to the processor. Alternatively or additionally, the processor may be configured to execute hard-coded functionality. As such, whether configured by hardware or software methods, or by a combination thereof, the processor may represent an entity (e.g., physically embodied in the circuitry) capable of performing operations according to an embodiment of the present invention while configured accordingly. Alternatively, as another example, when the processor is embodied as an executor of software instructions, the instructions may specifically configure the processor to perform the algorithms and/or operations described herein when the instructions are executed.

In some embodiments, the apparatus 200 may include input/output module 212 that may, in turn, be in communication with processor 202 to provide output to the user and, in some embodiments, to receive an indication of a user input. The input/output module 212 may comprise a user interface and may include a display and may comprise a web user interface, a mobile application, a client device, a kiosk, or the like. In some embodiments, the input/output module 212 may also include a keyboard, a mouse, a touch screen, touch areas, soft keys, a microphone, a speaker, or other input/output mechanisms. The processor 202 and/or a user interface module comprising the processor may be configured to control one or more functions of one or more user interface elements through computer program instructions (e.g., software and/or firmware) stored on a memory accessible to the processor (e.g., memory 216, and/or the like).

The communications module 214 may be any means such as a device or circuitry embodied in either hardware or a combination of hardware and software that is configured to receive and/or transmit data from/to a network and/or any other device, circuitry, or module in communication with the apparatus 200. In regard, the communications module 214 may include, for example, a network interface for enabling communications with a wired or wireless communication network. For example, the communications module 214 may include one or more network interface cards, antennae, buses, switches, routers, modems, and supporting hardware and/or software, or any other device suitable for enabling communications via a network. Additionally or alternatively, the communications interface may include the circuitry for interacting with the antenna(s) to cause transmission of signals via the antenna(s) or to handle receipt of signals received via the antenna(s).

Location determination module 204 includes hardware and software configured to facilitate determination of a current location of a device. In particular, location determination module 204 may be configured to determine the current location of, for example, a user-possessed device using any of a self-reporting process, GPS data, carrier signaling (cell tower location), IP address geo-mapping, Bluetooth beacons, proximity to known Wi-Fi hotspots, communication with cohort devices, or the like. Additionally or alternatively, location determination module 204 may be configured to access past location information (e.g., from the location history storage 218, which is described below) of any user-possessed device. In some embodiments, the past location information of a user-possessed device comprises one or more data points, each indicative of a past location and an associated time at which the user-possessed device was at the particular past location. In some embodiments, location determination module 204 may be configured to calculate a geographic area in which the user-possessed device is located. Location determination module 204 may receive information via a network interface provided by the communications module 214. Furthermore, location determination module 204 may be configured to determination co-location, and in particular, in some embodiments, to calculate a score indicative of a co-location probability between the location of the transaction and a current location of the at least one user-possessed device, such that the co-location probability being a probability that the transaction and the at least one user-possessed device are located within a same predefined geographic area However, it should also be appreciated that, in some embodiments, the location determination module 204 may include a separate processor, specially configured field programmable gate array (FPGA), or application specific interface circuit (ASIC) to perform the location determination. Location determination module 204 is therefore implemented using hardware components of the apparatus configured by either hardware or software for implementing these planned functions.

Possession determination module 206 includes hardware and software configured to facilitate possession determination. Additionally or alternatively, possession determination module 206 may be configured to determine user possession of a user device. Possession determination module 206 may receive information via a network interface provided by the communications module 214. However, it should also be appreciated that, in some embodiments, possession determination module 206 may include a separate processor, specially configured field programmable gate array (FPGA), or application specific interface circuit (ASIC) to perform the possession determination. Possession determination module 206 is therefore implemented using hardware components of the apparatus configured by either hardware or software for implementing these planned functions.

Frequented location determination module 208 includes hardware and software configured to facilitate determination of one or more frequented locations. Additionally or alternatively, frequented location determination module 208 may be configured to access location history information from, for example, location history storage 218 and/or possession history information, for example, from possession history storage 220, to identify, calculate, or otherwise determine one or more frequented locations, the frequent locations being, for example, home, work, or the like where it may be determined that the user in possession of the device at that location is the authorized. Frequented location determination module 208 may receive information via a network interface provided by the communications module 214. However, it should also be appreciated that, in some embodiments, frequented location determination module 208 may include a separate processor, specially configured field programmable gate array (FPGA), or application specific interface circuit (ASIC) to perform the possession determination. Frequented location determination module 208 is therefore implemented using hardware components of the apparatus configured by either hardware or software for implementing these planned functions.

Location tracking module 210 includes hardware and software configured to facilitate location tracking of a device. Additionally or alternatively, location tracking module 210 may be configured to access and/or receive, on a periodic basis, data indicative of a present location of a device. Additionally, the location tracking module 210 may be configured to store, for example, periodically, at least a portion of the received data indicative of the present location of the device with an associated time at which the user-possessed device was at the present location. Additionally or alternatively, location tracking module 210 may be configured to extrapolate the current location from the geographical past based on, for example, one or more of a determined direction, a determined speed, a determined destination, a determined mode of transportation. Location tracking module 210 may receive information via a network interface provided by the communications module 214. However, it should also be appreciated that, in some embodiments, Location tracking module 210 may include a separate processor, specially configured field programmable gate array (FPGA), or application specific interface circuit (ASIC) to perform the location tracking. Location tracking module 210 is therefore implemented using hardware components of the apparatus configured by either hardware or software for implementing these planned functions.

In some embodiments, authorization system 102 such as apparatus 200 may include location history storage 218. Location history storage 218 includes hardware and software configured to facilitate storage of location history information. For example, tracking a geographical path may be tracked and as data indicative of a present location of the device is received, the data, or some portion thereof, may be stored, for example, periodically, with an associated time at which the user-possessed device was at the present location. Additionally or alternatively, location history storage 218 may be configured to add, delete, or release stored information to third-parties. Additionally or alternatively, in some embodiments, location history storage 218 may be configured to allow the system to selectively release a portion of one or more location history information. In some embodiments, location history storage 218 may be configured to perform filtering, for example, by device, by user, by time, or a time period, or the like to identify information for use in responding to a request.

In some embodiments, authorization system 102 such as apparatus 200 may include possession history storage 220. Possession history storage 220 includes hardware and software configured to facilitate storage of possession history information. Furthermore, possession history storage 220 may be configured to enable, for example, frequented location determination module 208, access to possession history information to facilitate the determination of frequented location. Additionally or alternatively, possession history storage 220 may be configured to add, delete, or release stored information to third-parties. Additionally or alternatively, in some embodiments, possession history storage 220 may be configured to allow the system to selectively release a portion of one or more possession history information.

As will be appreciated, any such computer program instructions and/or other type of code may be loaded onto a computer, processor, or other programmable apparatus' circuitry to produce a machine, such that the computer, processor other programmable circuitry that execute the code on the machine created the means for implementing various functions, including those described herein.

As described above and as will be appreciated based on this disclosure, embodiments of the present invention may be configured as methods, mobile devices, backend network devices, and the like. Accordingly, embodiments may comprise various means including entirely of hardware or any combination of software and hardware.

Furthermore, embodiments may take the form of a computer program product on at least one non-transitory computer-readable storage medium having computer-readable program instructions (e.g., computer software) embodied in the storage medium. Any suitable computer-readable storage medium may be utilized including non-transitory hard disks, CD-ROMs, flash memory, optical storage devices, or magnetic storage devices.

### Example Operations for Implementing Embodiments of the Present Invention

In some embodiments, the system may be configured for facilitating the determination of the likelihood that a credit or debit card transaction is being performed by the actual card account holder, for example, to identify or detect a fraudulent transaction and/or provide information to a third party (e.g., a merchant, a payment processor, or the like) enabling the third party to determine whether a transaction may be fraudulent.

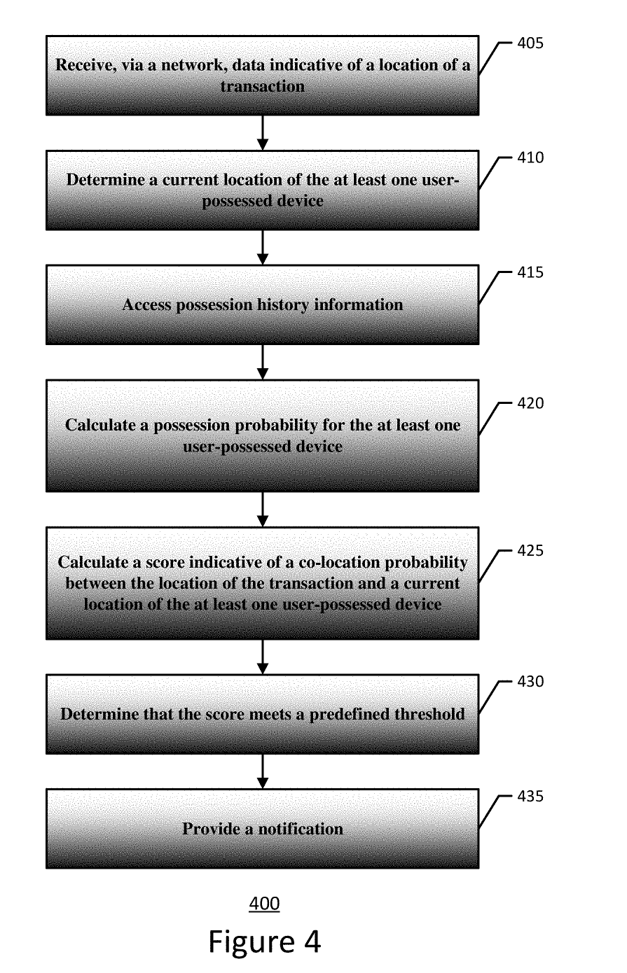

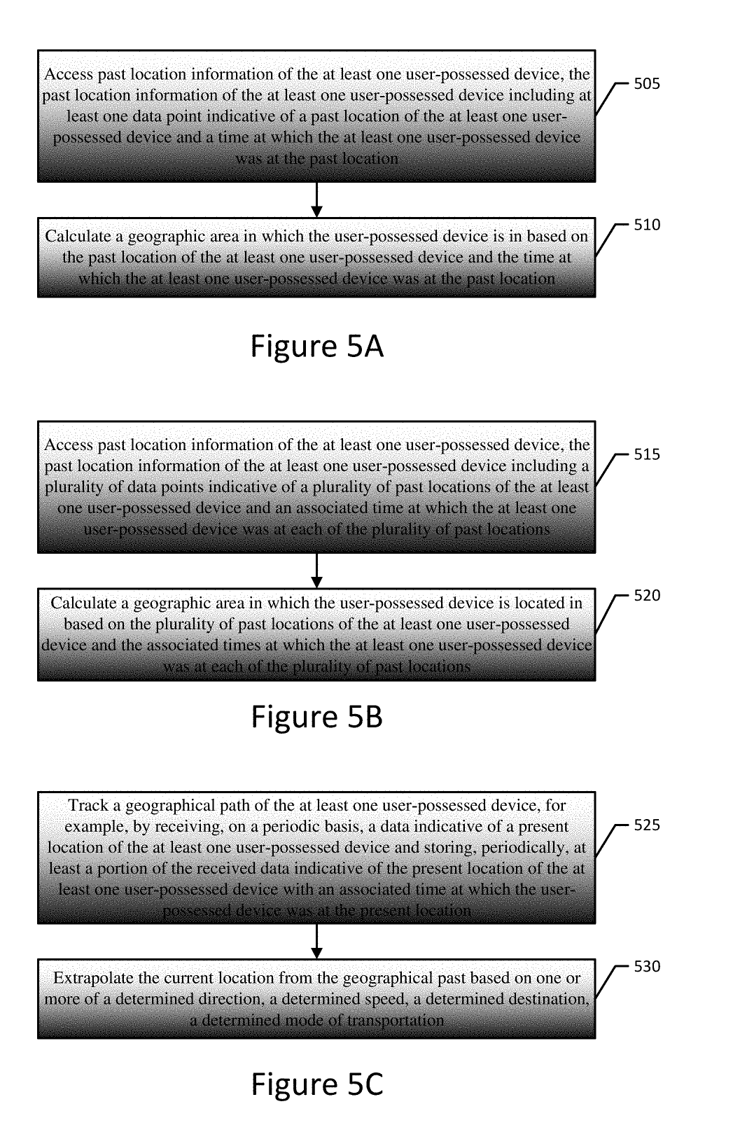

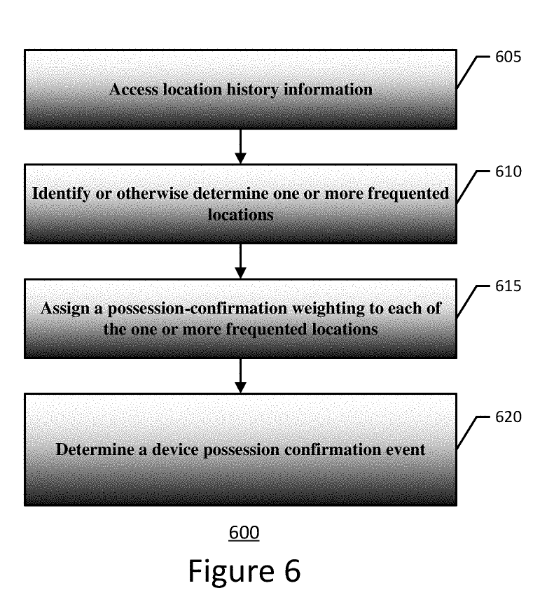

FIG. 4 illustrates a data flow diagram depicting data flow operations for a process for determining the likelihood that a credit or debit card transaction is being performed by the actual card account holder. FIGS. 5A, 5B, and 5C show flowcharts depicting example operations for a location determination process. FIG. 6 shows a flowchart depicting example operations for a device-possession determination process.

FIG. 4 shows a flowchart depicting data flow operations for a determination process, the determination process, for example, configured to facilitate the determination of the likelihood that a credit or debit card transaction is being performed by the actual card account holder.

As shown in block 405 of FIG. 4, an apparatus, for example, apparatus 200 embodied by, for example, authorization system 102, server 104, or the like, may be configured to receive, at a communications module, from, for example, a third-party entity, via a network, data indicative of a location of a transaction, an attempted transaction, or the like. In some embodiments, an apparatus, for example, apparatus 200 embodied by, for example, authorization system 102, server 104, or the like, may be configured to receive a query, the query comprising at least data indicative of a location of a transaction. The third-party entity may be any system or entity requesting user location for transaction spatial confirmation or other purposes.

In block 410 of FIG. 4, an apparatus, for example, apparatus 200 embodied by, for example, authorization system 102, server 104, or the like, may be configured to determine a current location of the at least one user-possessed device.

In some embodiments, the apparatus may be configured for determining, identifying, calculating, or accessing location information of at least one user-possessed device, the location information of the at least one user-possessed device including at least one data point indicative of a location of the at least one user-possessed device and a time at which the at least one user-possessed device was at the location.

The apparatus may be configured for determining the current location of the user-possessed device using at least one of self-reporting, GPS data, carrier signaling (cell tower location), IP address geo-mapping, Bluetooth beacons, proximity to known Wi-Fi hotspots, communication with cohort devices, or the like.

In some embodiments, the current location may comprise or be indicative of a geographic area, for example, defined in any of a number of ways, such as a radius from a particular access point. In some embodiments, current location may be defined as a set of geographic areas, each geographic area within the set of geographic areas being associated with a corresponding probability that the user-possessed device is or is not within the geographic area.

FIGS. 5A, 5B, and 5C describes, in more detail, how current location may be determination, which may be used in determining co-location. For example, determining co-location, and in some embodiments, the determination that the transaction is being performed by an authorized user may comprise determining that the user, or the user-possessed device is located within the same geographic area as the transaction. In other embodiments, determining co-location, and in some embodiments, the determination that the transaction is being performed by an authorized user may comprise determining that the user, or the user-possessed device is located within a predetermined distance of the transaction. In other embodiments, determining co-location, and in some embodiments, the determination that the transaction is being performed by an authorized user may comprise determining a co-location probability and one of either making the determination that that the transaction is being performed by an authorized user in the event that the co-location probability meets a predefined threshold or, in some embodiments, transmitting the co-location probability to the third-party entity with or without a recommendation or determination as to whether the transaction is being performed by an authorized user.

In some embodiments, determining a likelihood that the transaction is being performed by an authorized user is a function of one or more of a co-location probability, or co-location probability coupled with a device-possession probability.

As described above, a determination is made if and/or that the transaction is being performed by an authorized user. Also as described above, in some embodiments, a calculation or determination of one or more factors may be made that may be informative and/or determinative of whether the transaction is being performed by an authorized user. For example, the apparatus may be configured to determine a likelihood that the transaction is being performed by an authorized user. In some embodiments, the likelihood that the transaction is being performed by an authorized user may be calculated as a function of a co-location probability coupled with a device-possession probability or as a function of a device-possession probability.

Blocks 415 and 420 describe an optional device-possession probability determination, which may be factored into the determination of whether the transaction is being performed by an authorized user. As described above, in some embodiments, the likelihood that the transaction is being performed by an authorized user may be calculated as a function of a co-location probability coupled with a device-possession probability, and in some embodiments, the likelihood that the transaction is being performed by an authorized user may be calculated as a function of a device-possession probability.

In some embodiments, the apparatus may be configured to confirm a possession of the at least one user-possessed device. Absent undeniable or assailable evidence of user possession, the apparatus may be configured to calculate a user-possession probability. In some embodiments, the apparatus may be configured to utilize one or more biometric indicators in the calculation of the user-possession probability. Biometric indicators may refer to data representing a biometric feature associated with a user. Examples of a biometric indicator include, but are not limited to, a fingerprint scan, a face scan, an iris scan, and a walking gait.

Additionally or alternatively, the apparatus may be configured to utilize location tracking and the identification of particular frequented locations (e.g., home, work, etc.) to calculate user-possession probability. For example, as shown in block 415 of FIG. 4, an apparatus, for example, apparatus 200 embodied by, for example, authorization system 102, server 104, or the like, may be configured to access possession history information, and as shown in block 420 of FIG. 4, an apparatus, for example, apparatus 200 embodied by, for example, authorization system 102, server 104, or the like, may be configured to calculate a possession probability for the at least one user-possessed device, wherein the calculation of the score indicative of the co-location probability is a function of the possession probability.

FIG. 6 describes a process by which a determination may be made as to if and/or that a device is the possession of the user and/or how a device-possession probability may be calculated or determined.

Returning to FIG. 4, next, a determination is made. In some embodiments, the apparatus may be configured to determine if the transaction is being performed by an authorized user. Additionally or alternatively, the apparatus may be configured to determine that is being performed by an authorized user. In some embodiments, a calculation or determination of one or more factors may be made that may be informative and/or determinative of whether the transaction is being performed by an authorized user. For example, the apparatus may be configured to determine a likelihood that the transaction is being performed by an authorized user. In some embodiments, the likelihood that the transaction is being performed by an authorized user may be calculated as a function of a co-location probability. In some embodiments, the likelihood that the transaction is being performed by an authorized user may be calculated as a function of a co-location probability coupled with a device-possession probability. While in some embodiments, the likelihood that the transaction is being performed by an authorized user may be calculated as a function of a device-possession probability.

Specifically, in some embodiments, as shown in block 425 of FIG. 4, an apparatus, for example, apparatus 200 embodied by, for example, authorization system 102, server 104, or the like, may be configured to calculate a score indicative of a co-location probability between the location of the transaction and a current location of the at least one user-possessed device. The co-location probability may be a probability that the transaction and the at least one user-possessed device are located within a same predefined geographic area. In other embodiments, the co-location probability may be a probability that the transaction and the at least one user-possessed device are located within a pre-specified distance of each other.

Once the score is calculated, a determination may be made as to if, whether, or that the score meets a predefined threshold. For example, as shown in block 430 of FIG. 4, an apparatus, for example, apparatus 200 embodied by, for example, authorization system 102, server 104, or the like, may be configured to determine that the score meets a predefined threshold, or in some embodiments, determine that the score fails to meet a predefined threshold. In some embodiments, the determination may be made as to which of a plurality of predefined thresholds the score does meet.

In an instance in which the score does meet the predefined threshold, the apparatus may be configured to authorize the transaction and/or notify the third-party entity of at least one of the authorization or that the score does meet the predefined threshold. Whereas, in an instance in which the score does not meet the predefined threshold, the apparatus may be configured to deny or not authorize the transaction and/or notify and/or provide a notification to, for example, the third-party entity, of at least one of the authorization or denial of the transaction, or an indication that the score does or does not meet the predefined threshold, or which of a plurality of predefined threshold the score does or does not meet.

As such, as shown in block 435 of FIG. 4, an apparatus, for example, apparatus 200 embodied by, for example, authorization system 102, server 104, or the like, may be configured to provide a notification, or in some embodiments, authorize the transaction. The apparatus may be configured to provide the notification to the third-party entity (e.g., the requesting entity) and/or to a different entity (i.e., a payment processor). In some embodiments, the apparatus may be configured to provide the notification, the notification configured to notify or otherwise indicate to the receiving entity (e.g., whether it be the third-party entity, a requesting entity, and/or a different entity) that the transaction should or should not be authorized, and/or that the score does meet the predefined threshold, and/or that by the determination process of the apparatus, the likelihood that that a credit or debit card transaction is being performed by the actual card account holder meets a pre-defined threshold.

In some embodiments, the providing of the notification may comprise or otherwise indicate a binary result. As described above, in some embodiments, however, the providing of the notification may comprise or otherwise indicate more granular results, such as, for example, a confidence level. For example, where the location of a transaction does not match the location of the device supposedly attempting to engage in the transaction, the apparatus may provide a notification indicative of ‘no match’, a zero, or the like. While in other embodiments, wherein, again, the location of a transaction does not match the location of the device supposedly attempting to engage in the transaction, the apparatus may provide a notification comprising a probability that the transaction and the at least one user-possessed device are located within a same predefined geographic area, which may be any number, such as for example, (0%, 1.5%, 5%, etc.). As such, a binary result may be that of no match, whereas a more granular result may provide the transaction system with data necessary to make a risk assessment in determining whether to allow the transaction or, in some embodiments, for example, prompt for more information (e.g., a self-reported current location).

FIGS. 5A, 5B, and 5C each describe a process by a current location of a user-possessed device may be determined, and in some embodiments, utilized in a co-location determination process, the co-location determination comprised of, for example, calculating a score indicative of a co-location probability between the location of the transaction and a current location of the at least one user-possessed device. As described above, the co-location probability may be a probability that the transaction and the at least one user-possessed device are located within a same predefined geographic area.

In some embodiments, determining the current location of the at least one user-possessed device may comprise accessing location information indicative of a current location of the at least one user-possessed device. In other embodiments, determining the current location of the at least one user-possessed device may comprise accessing location information indicative of a path of the at least one user-possessed device. In other embodiments, determining the current location of the at least one user-possessed device may comprise accessing location information indicative of a geographic area in which the at least one user-possessed device is within (e.g., based on the last known location or the path information, maximum speed constraints, and logical routes, etc.). In other embodiments, determining the current location of the at least one user-possessed device may comprise accessing location information indicative of a geographic area in which the at least one user-possessed device is located within based on a last known location or a determined path of the at least one user-possessed device.

FIG. 5A illustrates a flowchart depicting data flow operations for a determination process, the determination process, for example, configured to determine a current location of a user-possessed device.

As shown in block 505 of FIG. 5A, an apparatus, for example, apparatus 200 embodied by, for example, authorization system 102, server 104, or the like, may be configured to access past location information of the at least one user-possessed device, the past location information of the at least one user-possessed device including at least one data point indicative of a past location of the at least one user-possessed device and a time at which the at least one user-possessed device was at the past location. As shown in block 510 of FIG. 5A, an apparatus, for example, apparatus 200 embodied by, for example, authorization system 102, server 104, or the like, may be configured to calculate a geographic area in which the user-possessed device is in based on the past location of the at least one user-possessed device and the time at which the at least one user-possessed device was at the past location.

FIG. 5B illustrates a flowchart depicting data flow operations for a determination process, the determination process, for example, configured to determine a current location of a user-possessed device.

As shown in block 515 of FIG. 5B, an apparatus, for example, apparatus 200 embodied by, for example, authorization system 102, server 104, or the like, may be configured to access past location information of the at least one user-possessed device, the past location information of the at least one user-possessed device including a plurality of data points indicative of a plurality of past locations of the at least one user-possessed device and an associated time at which the at least one user-possessed device was at each of the plurality of past locations. As shown in block 520 of FIG. 5B, an apparatus, for example, apparatus 200 embodied by, for example, authorization system 102, server 104, or the like, may be configured to calculate a geographic area in which the user-possessed device is located in based on the plurality of past locations of the at least one user-possessed device and the associated times at which the at least one user-possessed device was at each of the plurality of past locations.

FIG. 5C illustrates a flowchart depicting data flow operations for a determination process, the determination process, for example, configured to determine a current location of a user-possessed device.

As shown in block 525 of FIG. 5C, an apparatus, for example, apparatus 200 embodied by, for example, authorization system 102, server 104, or the like, may be configured to track a geographical path of the at least one user-possessed device, for example, by receiving, on a periodic basis, a data indicative of a present location of the at least one user-possessed device and storing, periodically, at least a portion of the received data indicative of the present location of the at least one user-possessed device with an associated time at which the user-possessed device was at the present location. As shown in block 530 of FIG. 5C, an apparatus, for example, apparatus 200 embodied by, for example, authorization system 102, server 104, or the like, may be configured to extrapolate the current location from the geographical past based on one or more of a determined direction, a determined speed, a determined destination, a determined mode of transportation.

FIG. 6 describes a process by which a determination may be made as to if and/or that a device is the possession of the user and/or how a device-possession probability may be calculated or determined.

In an example embodiment, a device possession confirmation event may be used to confirm a user's possession of the device. In an example embodiment, the device possession confirmation event may be a message, such as a SMS message, sent to the second user device containing the configured link. In some alternative embodiments, other methods may be employed to link a user identity, or a device they possess, to the certificate information. In some embodiments, these methods may include sending a one-time password over SMS to a user device, entering a code on a user device from a device or application running the time-based one-time password algorithm, entering a code on a user device from a device or application running the HMAC-based one-time password algorithm, such as Google Authenticator or Authy Authenticator, using a FIDO key on a user device, entering a biometric indicator (e.g., a fingerprint scan, face scan, iris scan, walking gait) on a user device, drawing a pattern on a user device, or other methods.

As shown in block 605 of FIG. 6, an apparatus, for example, apparatus 200 embodied by, for example, authorization system 102, server 104, or the like, may be configured to access location history information

As shown in block 610 of FIG. 6, an apparatus, for example, apparatus 200 embodied by, for example, authorization system 102, server 104, or the like, may be configured to Identify or otherwise determine one or more frequented locations

As shown in block 615 of FIG. 6, an apparatus, for example, apparatus 200 embodied by, for example, authorization system 102, server 104, or the like, may be configured to assign a possession-confirmation weighting to each of the one or more frequented locations.

As shown in block 620 of FIG. 6, an apparatus, for example, apparatus 200 embodied by, for example, authorization system 102, server 104, or the like, may be configured to determine a device possession confirmation event. In some embodiments, a device possession confirmation event may be a time at which the device returns to or is otherwise located at one of the one or more frequented locations.

Possession probability decays over time following a linear, logarithmic, AI-determined profile, or other decay algorithm. The decay function may be a function of the possession confirmation weighting and/or the specific location or location type (home/work, etc.). The system also considers device motion when calculating possession probability. For example, if multiple user devices produce conflicting location signals, the system may reduce the calculated possession probability for one or more of the devices. The system considers individual, cohort, and general population usage patterns in the calculation of device possession probability. For example, a mobile phone is more likely to remain in the possession of a user throughout their travels than a laptop computer. If both devices are traveling in unison, the possession probability of each device would be presumed to be higher than if one is traveling without the other. User device possession can also be confirmed by user entry of biometric information into the device, by carrier signaling (authorized usage, header-injection/enrichment, or other in-band or out-of-band techniques), by user response to a query from an application running on the device, by user response to an SMS or other message received on the device, by an authentication event when logging into an Internet service, or by other techniques.

FIGS. 4, 5A, 5B, 5C, and 6 illustrate example flowchart of the example operations performed by a method, apparatus, and computer program product in accordance with an embodiment of the present invention. It will be understood that each block of the flowcharts, and combinations of blocks in the flowcharts, may be implemented by various means, such as hardware, firmware, processor, circuitry, and/or other devices associated with execution of software including one or more computer program instructions.

For example, in reference to FIGS. 4, 5A, 5B, 5C, and 6, one or more of the procedures described herein may be embodied by computer program instructions. In this regard, the computer program instructions which embody the procedures described above may be stored by a memory 214 of an apparatus employing an embodiment of the present invention and executed by a processor 202 in the apparatus.

As will be appreciated by one of ordinary skill in the art, any such computer program instructions may be loaded onto a computer or other programmable apparatus (e.g., hardware) to produce a machine, such that the resulting computer or other programmable apparatus provides for implementation of the functions specified in the block(s) of the corresponding flowchart. These computer program instructions may also be stored in a non-transitory computer-readable storage memory that may direct a computer or other programmable apparatus to function in a particular manner, such that the instructions stored in the computer-readable storage memory produce an article of manufacture, the execution of which implements the function specified in the block(s) of the flowchart. The computer program instructions may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the block(s) of the flowchart. As such, the operations of FIGS. 4, 5A, 5B, 5C, and 6 when executed, convert a computer or processing circuitry into a particular machine configured to perform an example embodiment of the present invention. Accordingly, the operations of FIGS. 4, 5A, 5B, 5C, and 6 define an algorithm for configuring a computer or processing circuitry to perform an example embodiment.

Accordingly, blocks of the flowchart support combinations of means for performing the specified functions and combinations of operations for performing the specified functions. It will also be understood that one or more blocks of the flowchart, and combination of blocks in the flowchart, can be implemented by special-purpose hardware-based computer systems which perform the specified functions, or combinations of special purpose hardware and computer instructions.

In some embodiments, certain ones of the operations herein may be modified or further amplified as described below. Moreover, in some embodiments, additional optional operations may also be included. It should be appreciated that each of the modifications, optional additions, or amplifications below may be included with the operations above either alone or in combination with any others among the features described herein.

Many modifications and other embodiments of the inventions set forth herein will come to mind to one skilled in the art to which these embodiments of the invention pertain having the benefit of the teachings presented in the foregoing descriptions and the associated drawings. Therefore, it is to be understood that the embodiments of the invention are not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A method for facilitating determination of whether a credit or debit card transaction is being performed by an authorized user, the method comprising:
receiving, from a third-party entity, via a network, a query, the query comprising at least data indicative of a location of a transaction;
calculating a co-location probability between the location of the transaction and a current location of the at least one user-possessed device, the co-location probability being a probability that the transaction and the at least one user-possessed device are located within a same predefined geographic area;
determining that the co-location probability meets a predefined threshold; and
providing a notification indicating that the co-location probability meets a predefined threshold.

2. The method of claim 1, further comprising:
determining the current location of the at least one user-possessed device.

3. The method of claim 2, further comprising:
determining the current location of the user-possessed device using at least one of self-reporting, GPS data, carrier signaling, IP address geo-mapping, Bluetooth beacons, proximity to known Wi-Fi hotspots, communication with cohort devices.

4. The method of claim 2, wherein determining the current location of the at least one user-possessed device comprises:
(i) accessing past location information of the at least one user-possessed device, the past location information of the at least one user-possessed device including at least one data point indicative of a past location of the at least one user-possessed device and a time at which the at least one user-possessed device was at the past location, and
(ii) calculating a geographic area in which the user-possessed device is in based on the past location of the at least one user-possessed device and the time at which the at least one user-possessed device was at the past location.

5. The method of claim 2, wherein determining the current location of the at least one user-possessed device comprises:
(i) accessing past location information of the at least one user-possessed device, the past location information of the at least one user-possessed device including a plurality of data points indicative of a plurality of past locations of the at least one user-possessed device and an associated time at which the at least one user-possessed device was at each of the plurality of past locations, and
(ii) calculating a geographic area in which the user-possessed device is located in based on the plurality of past locations of the at least one user-possessed device and the associated times at which the at least one user-possessed device was at each of the plurality of past locations.

6. The method of claim 2, wherein determining the current location of the at least one user-possessed device comprises:
accessing location information indicative of a geographic area in which the at least one user-possessed device is located within based on a last known location or a determined path of the at least one user-possessed device.

7. The method of claim 2, wherein determining the current location of the at least one user-possessed device comprises:
tracking a geographical path of the at least one user-possessed device by: receiving, on a periodic basis, data indicative of a present location of the at least one user-possessed device; and
storing, periodically, at least a portion of the received data indicative of the present location of the at least one user-possessed device with an associated time at which the user-possessed device was at the present location; and
extrapolating the current location from the geographical past based on a determined direction, a determined speed, a determined destination, a determined mode of transportation.

8. The method of claim 2, wherein the current location comprises a set of geographic areas, each geographic area within the set of geographic area being associated with a corresponding probability that the user-possessed device is within the geographic area.

9. The method of claim 1, further comprising:
calculating a possession probability for the at least one user-possessed device,
wherein the calculation of the co-location probability is further a function of the possession probability.

10. The method of claim 9, further comprising:
accessing location history information;
identifying one or more frequented locations; and
determining a device possession confirmation event, the device-possession event being a time at which the device returns to or is otherwise located at one of the one or more frequented locations.

11. An apparatus for facilitating determination of whether a credit or debit card transaction is being performed by an authorized user, the apparatus comprising at least one processor and at least one memory including computer program code, the at least one memory and the computer program code configured to, with the processor, cause the apparatus to at least:
receiving, from a third-party entity, via a network, a query, the query comprising at least data indicative of a location of a transaction;
calculating a co-location probability between the location of the transaction and a current location of the at least one user-possessed device, the co-location probability being a probability that the transaction and the at least one user-possessed device are located within a same predefined geographic area;
determining that the co-location probability meets a predefined threshold; and
providing a notification indicating that the co-location probability meets a predefined threshold.

12. An apparatus according to claim 11, wherein the at least one memory and the computer program code are further configured to, with the processor, cause the apparatus to:
determine the current location of the at least one user-possessed device.

13. The apparatus of claim 12, wherein the at least one memory and the computer program code are further configured to, with the processor, cause the apparatus to:
determine the current location of the user-possessed device using at least one of self-reporting, GPS data, carrier signaling, IP address geo-mapping, Bluetooth beacons, proximity to known Wi-Fi hotspots, communication with cohort devices.

14. The apparatus of claim 12, wherein the computer program code configured to, with the processor, cause the apparatus to determine the current location of the at least one user-possessed device further comprises computer program code, wherein the at least one memory and the computer program code are further configured to, with the processor, cause the apparatus to:
(i) access past location information of the at least one user-possessed device, the past location information of the at least one user-possessed device including at least one data point indicative of a past location of the at least one user-possessed device and a time at which the at least one user-possessed device was at the past location, and
(ii) calculate a geographic area in which the user-possessed device is in based on the past location of the at least one user-possessed device and the time at which the at least one user-possessed device was at the past location.

15. The apparatus of claim 12, wherein the computer program code configured to, with the processor, cause the apparatus to determine the current location of the at least one user-possessed device further comprises computer program code, wherein the at least one memory and the computer program code are further configured to, with the processor, cause the apparatus to:
(i) access past location information of the at least one user-possessed device, the past location information of the at least one user-possessed device including a plurality of data points indicative of a plurality of past locations of the at least one user-possessed device and an associated time at which the at least one user-possessed device was at each of the plurality of past locations, and
(ii) calculate a geographic area in which the user-possessed device is located in based on the plurality of past locations of the at least one user-possessed device and the associated times at which the at least one user-possessed device was at each of the plurality of past locations.

16. The apparatus of claim 12, wherein the computer program code configured to, with the processor, cause the apparatus to determine the current location of the at least one user-possessed device further comprises computer program code, wherein the at least one memory and the computer program code are further configured to, with the processor, cause the apparatus to:
access location information indicative of a geographic area in which the at least one user-possessed device is located within based on a last known location or a determined path of the at least one user-possessed device.

17. The apparatus of claim 12, wherein the computer program code configured to, with the processor, cause the apparatus to determine the current location of the at least one user-possessed device further comprises computer program code, wherein the at least one memory and the computer program code are further configured to, with the processor, cause the apparatus to:
track a geographical path of the at least one user-possessed device by: receiving, on a periodic basis, data indicative of a present location of the at least one user-possessed device; and storing, periodically, at least a portion of the received data indicative of the present location of the at least one user-possessed device with an associated time at which the user-possessed device was at the present location; and
extrapolate the current location from the geographical past based on a determined direction, a determined speed, a determined destination, a determined mode of transportation.

18. The apparatus of claim 12, wherein the current location comprises a set of geographic areas, each geographic area within the set of geographic area being associated with a corresponding probability that the user-possessed device is within the geographic area.

19. The apparatus of claim 11, wherein the at least one memory and the computer program code are further configured to, with the processor, cause the apparatus to:
calculate a possession probability for the at least one user-possessed device,
wherein the calculation of the co-location probability is further a function of the possession probability.

20. The apparatus of claim 19, wherein the at least one memory and the computer program code are further configured to, with the processor, cause the apparatus to:
access location history information;
identify one or more frequented locations; and
determine a device possession confirmation event, the device-possession event being a time at which the device returns to or is otherwise located at one of the one or more frequented locations.

21. A computer program product configured for facilitating determination of whether a credit or debit card transaction is being performed by an authorized user, the computer program product comprising at least one non-transitory computer-readable storage medium having computer-executable program code instructions stored therein, the computer-executable program code instructions comprising program code instructions for:
receiving, from a third-party entity, via a network, a query, the query comprising at least data indicative of a location of a transaction;
calculating a co-location probability between the location of the transaction and a current location of the at least one user-possessed device, the co-location probability being a probability that the transaction and the at least one user-possessed device are located within a same predefined geographic area;
determining that the co-location probability meets a predefined threshold; and
providing a notification indicating that the co-location probability meets a predefined threshold.

22. The computer program product according to claim 21, wherein the computer-executable program code instructions further comprise program code instructions for:
determining the current location of the at least one user-possessed device.

23. The computer program product of claim 21, wherein the computer-executable program code instructions further comprise program code instructions for:
determining the current location of the user-possessed device using at least one of self-reporting, GPS data, carrier signaling, IP address geo-mapping, Bluetooth beacons, proximity to known Wi-Fi hotspots, communication with cohort devices.

24. The computer program product of claim 22, wherein determining the current location of the at least one user-possessed device comprises:
(i) accessing past location information of the at least one user-possessed device, the past location information of the at least one user-possessed device including at least one data point indicative of a past location of the at least one user-possessed device and a time at which the at least one user-possessed device was at the past location, and
(ii) calculating a geographic area in which the user-possessed device is in based on the past location of the at least one user-possessed device and the time at which the at least one user-possessed device was at the past location.

25. The computer program product of claim 22, wherein determining the current location of the at least one user-possessed device comprises:
(i) accessing past location information of the at least one user-possessed device, the past location information of the at least one user-possessed device including a plurality of data points indicative of a plurality of past locations of the at least one user-possessed device and an associated time at which the at least one user-possessed device was at each of the plurality of past locations, and
(ii) calculating a geographic area in which the user-possessed device is located in based on the plurality of past locations of the at least one user-possessed device and the associated times at which the at least one user-possessed device was at each of the plurality of past locations.

26. The computer program product of claim 22, wherein determining the current location of the at least one user-possessed device comprises:
accessing location information indicative of a geographic area in which the at least one user-possessed device is located within based on a last known location or a determined path of the at least one user-possessed device.

27. The computer program product of claim 22, wherein determining the current location of the at least one user-possessed device comprises:
tracking a geographical path of the at least one user-possessed device by: receiving, on a periodic basis, data indicative of a present location of the at least one user-possessed device; and storing, periodically, at least a portion of the received data indicative of the present location of the at least one user-possessed device with an associated time at which the user-possessed device was at the present location; and
extrapolating the current location from the geographical past based on a determined direction, a determined speed, a determined destination, a determined mode of transportation.

28. The computer program product of claim 22, wherein the current location comprises a set of geographic areas, each geographic area within the set of geographic area being associated with a corresponding probability that the user-possessed device is within the geographic area.

29. The computer program product of claim 21, wherein the computer-executable program code instructions further comprise program code instructions for:
calculating a possession probability for the at least one user-possessed device,
wherein the calculation of the co-location probability is further a function of the possession probability.

30. The computer program product of claim 29, wherein the computer-executable program code instructions further comprise program code instructions for:
accessing location history information;
identifying one or more frequented locations; and
determining a device possession confirmation event, the device-possession event being a time at which the device returns to or is otherwise located at one of the one or more frequented locations.
